(19) United States
(12) Patent Application Publication
(10) Pub. No.: US 2003/0101785 A1
(43) Pub. Date: Jun. 5, 2003

(54) Micronutrient compositions including aminophosphonic acid and chelated metal ions

(75) Inventors: Wei Jia, Castro Valley, CA (US); Edge R. Wang, Castro Valley, CA (US)

Correspondence Address: Wei Jia, 18886 Sydney Circle, Castro Valley, CA, 94546, US

(73) Assignee: Wei Jia

(21) Appl. No.: 10/011,827

(22) Filed: Dec. 4, 2001

(51) Int. Cl. C05F 11/02; C05F 1/00

(52) U.S. Cl. 71/24; 71/27

(57) ABSTRACT

The present invention is directed to micronutrients and compositions, and to methods for their preparation and administration to plants. The micronutrient compositions include chelated metal ions of the transition and alkaline earth metals The chelated metal solutions are prepared by complexing metal cations using an organic phosphonic acid The micronutrient compositions are stable at the pH about 6.5-9. The source of the metal ions may be any biologically acceptable metal salt, such as chloride, sulfate, nitrate, oxide, hydroxide and carbonate and other biologically compatible salts of the metal cations. The preferred chelating agents are aminophosphonic acids, such as ethylenediaminetetramethylene phosphonic acid. Micronutrient solutions containing such chelated metals are stable at neutral and alkaline pH and are used as liquid fertilizers, or mixed with other fertilizers to prepare clear, liquid fertilizer compositions for delivery of trace metals to plants.

### BACKGROUND OF THE INVENTION

I. Field of the Invention

The present invention generally relates to fertilizer additives and fertilizer compositions and to methods for their preparation and use. More specifically, the present invention is directed to fertilizer additives and compositions including chelated metal ions in the form of aminophosphonate complexes to provide micronutrients necessary for plant growth.

II. Description of the Background

In the past, crops depended mainly on the natural fertility of the soil for their nutrients. Micronutrient deficiencies were rarely seen. Nowadays, chemical fertilizers containing nitrogen, phosphorus and potassium are supplying most of the nutrients needed by crops. However, with each cropping season, micronutrients are removed in the harvested crop and are not being replaced. The result of this mining of nutrients is widespread micronutrient deficiency problems in most areas of the world. These include shortages of zinc, iron, molybdenum, boron, manganese, copper, calcium and magnesium etc.

Both soil and foliar application of chelated metal ions may prevent, correct or minimize crop deficiencies. Chelated complexes have been favored because the chelated metal ions remain soluble in different or changing environments.

Conventional products have used synthetic chelates, mainly aminocarboxylic acid such as EDTA (ethylenediaminetetraacetic acid) and its derivatives such as HEDTA (hydroxyethylenediamine-triacetic acid). However, even though widely accepted for the administration of metal ions, they are not the best metal chelating agents to form micronutrients. The use of multidentate aminophosphonic acid as a chelating agent to provide an inexpensive alternative has been proposed. Phosphonic acids, such as ethylenediaminetetramethylenephosphonic acid (EDTMP), nitrilotrimethylenephosphonic acid (NTMP), tetraazacyclododecanetetramethylenephosphonic acid (DOTMP), diethylene-triaminepentamethylenephosphonic acid (DTPMP), contain nitrogen and phosphorus atoms in the molecule and can readily form stable complexes with transition and alkaline earth metals. The advantages of aminophosphonic acids over aminocarboxylic acids as chelating agents are: (1) additive solutions containing such metal-phosphonate complexes are stable at neutral and alkaline pH and therefore, can be used to prepare stable liquid fertilizer, in the form of clear water solution, for delivery of micronutrients to plants, whereas aminocarboxylic acids can not form stable metal chelates when the pH is higher than 4; (2) metal-phosphonate complexes themselves contain nitrogen and phosphorus nutrients in the molecules, and therefore, can deliver organic nitrogen and phosphorus nutrients to plants over a certain period of time; (3) small or trace amount of metals such as Ca, Mg, Fe, Mn, Zn, Cu. etc. can be complexed by one multidentate aminophosphonic acid, thus, a single molecule of metal-phosphonate complex can provide organic nitrogen, phosphorus, calcium, magnesium, iron, manganese, zinc, copper to the plants. The nitrogen and phosphorus atoms in the organic compounds along with metal ions are slowly released as the molecules metabolize and break down in the plants.

Accordingly, there has been a strong need for more efficient, more chemically stable and more environmental friendly micronutrient and compositions to deliver single or many trace metals to plants and for methods of producing such fertilizers with the required metal nutrients necessary for plant growth. The present invention solves those needs.

### SUMMARY OF THE INVENTION

The present invention is directed to novel micronutrient and compositions useful for delivering trace levels of metal ions to plant tissue in chelated forms at a neutral pH. These additives and compositions are prepared using one or a mixture of several aminophosphonic acids as chelating agents to complex the metal ions and to control the pH of the additive solution.

It is a general aspect of the present invention to provide a formulation for a clear, liquid micronutrient or fertilizer additive, comprising water, an organic acid, preferably selected from the aminophosphonic acids having about 3 to 5 phosphorus atoms, at least one metal salt wherein the metal is preferably selected from the group consisting of the alkaline earth and transition metals. In the presently most preferred embodiments, the present invention provides compositions and methods for chelating metal ions from their metal salts or oxides wherein the metal is selected from the group consisting of calcium, magnesium, iron, cobalt, copper, zinc, and mixtures thereof, using aminophosphonic acid selected from the group consisting of nitrilotrimethylenephosphonic acid (NTMP), hydroxyethylenediaminetrimethylenephosphonic acid (HEDTMP), bis-(aminomethyl)-norbornyltetramethylene-phosphonic acid (NBTP), ethylenedianine-tetramethylenephosphonic acid (EDTMP), tetraazacyclododecanetetramethylene phosphonic acid (DOTMP), and diethylenetriaminepenta-methylene phosphonic acid (DTPMP). Such fertilizer additive solutions may be generally referred to hereinafter at times as “micronutrient” or “fertilizer additives”.

It is another aspect of the present invention to provide a clear liquid fertilizer composition comprised of the foregoing micronutrient blended with a liquid fertilizer. Any conventional liquid fertilizer may be used. Typically liquid fertilizers include the N—P—K fertilizers selected from the group containing at least one nutrient selected from the group consisting of nitrogen, phosphorus and potassium. In the present invention fertilizer compositions are preferably formulated so that the concentration of the metal from the additive solution is about 0.000001 to about 5.0 percent-by-weight in the final fertilizer composition. The final fertilizer compositions will typically have a neutral or slightly basic pH.

It is another aspect of the present invention to provide a method for formulating clear liquid fertilizer compositions comprising micronutrient containing chelated metals. The preparation involves completing metal cations with an aminophosphonic acid. The solution is stabilized and adjusted by addition of sufficient quantity of basic chemicals selected from the group consisting of potassium hydroxide, sodium hydroxide, potassium carbonate, and sodium carbonate to maintain the pH of solution about 6.5-9, more preferably from about 7-8.

The pH adjusted micronutrient solutions are then used as liquid fertilizer, or blended with a conventional liquid fertilizer solutions which contain one of the essential nutrients, i.e., nitrogen, phosphorous, or potassium. Preferred weight ratios for preparing the liquid fertilizer compositions are about 1 part micronutrient solution to about 1-10 parts conventional fertilizer solution. These compositions are preferably formulated to provide to about 0.0000001 to sufficient quantity of basic chemicals selected from the group consisting of potassium hydroxide, sodium hydroxide, potassium carbonate, and sodium carbonate to maintain the pH of solution about 6.5-95.0 percent-by-weight metal in the fertilizer composition at a generally neutral pH.

### DETAILED DESCRIPTION OF THE PREFERRED EMBODIMENT

The present invention provides an improved and more effective fertilizer composition for delivering trace levels of metal ions to plant tissues. The compositions and methods of the present invention provide chelated metal ions in an aqueous micronutrient solution. Chelation is achieved using one or several aminophosphonic acids.

The organic acid may be an aminophosphonic acid, preferably an aminophosphonic acid having 3-5 phosphorus atoms. Ethylenediaminetetramethylenephosphonic acid has been found to be the presently most preferred organic acid primarily due to its chemical stability of the metal chelates, low production cost and environmental compatibility. Other foregoing aminophosphonic acids are similar to EDTMP in chemistry and therefore, can be used as chelating agents.

The metal ions in the micronutrient may be the biologically required trace metals. The metal ions in the micronutrient solution are typically selected from the group consisting of the alkaline earth and transition metals. The preferred compositions include at least one metal selected from the group consisting of calcium, magnesium, manganese, iron, cobalt, copper, zinc, molybdenum and mixtures thereof. The metal ions may be provided by any salt soluble in the aminophosphonic acid or water solution. While the metal may be present in any quantity, it is preferred that the micronutrient solution contain about 0.000001 to about 5.0 percent-by-weight of metal ions.

In the present invention the micronutrient solutions are either used as liquid fertilizer or blended with conventional liquid fertilizers. The conventional liquid fertilizers are chosen from the group of fertilizers containing at least one nutrient selected from the group consisting of nitrogen, phosphorus and potassium. The conventional fertilizers are commonly referred to as “N—P—K fertilizers”. A sufficient amount of the micronutrient solution is blended with the selected conventional liquid fertilizer so that the concentration of the complexed metal supplied by the additive solution is about 0.0000001 to about 5.0 percent-by-weight in the final fertilizer composition. This blending is typically achieved when the weight ratio of fertilizer additive to liquid fertilizer is about 1 part micronutrient to about 1-10 parts liquid fertilizer.

Micronutrient and compositions in accord with the present invention may be prepared by the following method A solution is prepared by mixing an organic acid and a basic chemical in water. The preferred organic acids are selected from the group of aminophosphonic acids having from 3-5 phosphorus atoms. The most preferred phosphonic acid is ethylenediaminetetramethylene-phosponic acid. The preferred basic chemicals are selected from the group consisting of potassium hydroxide, sodium hydroxide, calcium oxide, calcium hydroxide, potassium carbonate, and sodium carbonate; The most preferred basic chemicals are potassium hydroxide and potassium carbonate. A metal salt, selected from the salts of biologically required trace metals, preferably the alkaline earth and transition metals, is dissolved in the solution. The solution containing chelated metals is then adjusted by adding a sufficient quantity of basic chemical to bring the pH of the solution to about 6.5-9, preferably to about 7.5. The resulting solution of complexed metal ions is typically clear and free of any precipitate. These solutions have been found to be quite stable and useful to provide trace metals to plant tissue. This micronutrient solution can be either used as liquid fertilizer, or blended with a conventional, liquid N—P—K fertilizer. The composition of the blend is also typically a clear, liquid fertilizer solution, preferably containing about 0.0000001 to about 5.0 percent-by-weight metal and having a neutral pH.

The fertilizer compositions described above and/or prepared in accord with the foregoing procedures may be applied to the ground surrounding a plant or to the foliage of the plant by conventional methods to deliver readily absorbable trace metals to the plant tissue. Thus, the micronutrient and compositions of the present invention provide an effective and environmentally friendly source of trace metals for use in a wide range of agricultural applications.

While the liquid composition itself is useful for foliar application, it is also an advantage of this invention that the composition can be formed into granules for soil application. Broadly, granulated composites in accordance with the invention can be formed by granulating a mixture comprising a carrier of organic or inorganic polymer, such as humic acid, fulvic acid and/or pearlite absorbed with said micronutrient consisting of magnesium, calcium zinc, iron, manganese, copper, boron, cobalt, and mixtures thereof. The granulation of the mixture can be carried out using any known granulation method. One preferred method of forming granulated composites in accordance with the invention involves mixing a conventional fertilizer such as ammonium sulfate, and the carrier absorbed with said micronutrient, and/or a binding agent such as lignosulfonates or attapulgite clay to form a mixture. The resulting mixture is then processed in any granulation machinery known in the art, including but not limited to rotary drum granulators, rotary pan granulators, fluid bed granulators, or prilling towers. As the chemical reactions proceed, the granules will harden.

### EXAMPLE 1

A micronutrient containing 0.6% chelated calcium was prepared by adding 700 grams of ethylenediaminetetramethylenephosphonic acid monohydrate (EDTMP H₂O) to 8 liters of water. To this suspension was added 114 grams of calcium hydroxide, followed by 392 grams of potassium hydroxide. The solution was stirred. After allowing the chemicals to mix and dissolve, 2 liters of water were added to dilute the solution to 0.6% calcium. The resulting solution containing organic N, P, ionic K, and chelated Ca, was clear and colorless and had a pH of 7. This micronutrient solution was either used as an individual liquid fertilizer or mixed with conventional liquid fertilizer containing nitrogen, phosphorus, or potassium to give a clear fertilizer compositions.

### EXAMPLE 2

A micronutrient containing 0.4% chelated iron was prepared by dissolving 700 grams of ethylenediaminetetramethylenephosphonic acid monohydrate (EDTMP H₂O) with 604 grams of potassium hydroxide in 15 liters of water. Then 428 grams of ferrous sulfate (FeSO₄ 7H₂O) was added to the solution. After the ferrous sulfate was dissolved, 5 liters of water were added to prepare a fertilizer additive containing 0.4% of chelated Fe. The resulting solution appeared to be dark green, having a pH of about 7. This solution contained organic N, P, ionic K and S, and chelated Fe. This micronutrient solution was either used as an individual liquid fertilizer or mixed with conventional liquid fertilizer containing nitrogen, phosphorus, or potassium to give a clear fertilizer compositions.

### EXAMPLE 3

A micronutrient containing 0.3% chelated magnesium was prepared by adding 820 grams of ethylenediaminetetramethylenephosphonic acid monohydrate (EDTMP H₂O) to 15 liters of water. To this suspension was added 108 grams of magnesium hydroxide, followed by 459 grams of potassium hydroxide. The solution was stirred. After allowing the chemicals to mix and dissolve, 5 liters of water were added to dilute the solution to 0.2% magnesium. The resulting solution containing organic N, P, ionic K, and chelated Mg, was clear and colorless and had a pH of about 7.5. This micronutrient solution was either used as an individual liquid fertilizer or mixed with conventional liquid fertilizer containing nitrogen, phosphorus, or potassium to give a clear fertilizer compositions.

### EXAMPLE 4

A micronutrient containing 0.6% chelated copper was prepared by dissolving 900 grams of ethylenediaminetetramethylenephosphonic acid monohydrate (EDTMP H₂O) with 776 grams of potassium hydroxide in 15 liters of water. Then 495 grams of cupric sulfate heptahydrate (CuSO₄ 5H₂O) was added to the solution. After the cupric sulfate was dissolved, 5 liters of water were added to prepare a fertilizer additive containing 0.6% of chelated copper. The resulting solution appeared to be dark blue, having a pH of about 7. This fertilizer additive contained organic N, P. ionic K and S, and chelated Cu. This micronutrient solution was either used as an individual liquid fertilizer or mixed with conventional liquid fertilizer containing nitrogen, phosphorus, or potassium to give a clear Belize compositions.

### EXAMPLE 5

A micronutrient containing 0.6% chelated was produced by dissolving 442 grams of ethylenediaminetetramethylenephosphonic acid monohydrate (EDTMP H₂O) and 381 grams of potassium hydroxide in 6 liters of water. Then 174 grams of zinc sulfate monohydrate was added to the solution. After zinc sulfate was dissolved, 4 liters of water were added to prepare a clear solution having a pH of 7.5. This fertilizer additive contained organic N, P, ionic K and S, and chelated Zn. This micronutrient solution was either used as an individual liquid fertilizer or mixed with conventional liquid fertilizer containing nitrogen, phosphorus, or potassium to give a clear fertilizer compositions.

### EXAMPLE 6

A micronutrient containing 0.5% chelated manganese was prepared by dissolving 454 grams of ethylenediaminetetramethylenephosphonic acid monohydrate (EDTMP H₂O) with 392 grams of potassium hydroxide in 7 liters of water. Then 169 grams of manganese sulfate monohydrate (MnSO₄ H₂O) was added to the solution. After the manganese sulfate was dissolved, 3 liters of water were added to prepare a fertilizer additive containing 0.5% of chelated manganese. The resulting solution appeared to be clear, having a pH of about 7. This fertilizer additive contained organic N, P, ionic K and S, and chelated Mn. This micronutrient solution was either used as an individual liquid fertilizer or mixed with conventional liquid fertilizer containing nitrogen, phosphorus, or potassium to give a clear fertilizer compositions.

### EXAMPLE 7

A clear, green or brown micronutrient solution containing nitrogen, phosphorus, potassium, sulfur, magnesium, calcium, zinc, manganese, copper, boron, molybdenum, and iron was prepared by mixing 350 grams of ethylenediaminetetramethylenephosphonic acid monohydrate (EDTMP H₂O), 118 grams of calcium nitrate, 223 grams of potassium sulfate, 29.6 grams of magnesium nitrate, 259 grams of potassium hydroxide and 286 grams of ammonium nitrate in 5 liters of water. To this solution was added slowly with stirring, 250 milligrams of manganese sulfate monohydrate, 144 milligrams of zinc sulfate septahydrate, 500 milligrams of ferric sulfate septahydrate and 20 milligrams of copper sulfate heptahydrate. Then 245 milligrams of sodium molybdate dihydrate and 1.7 grams of boric acid were added. The resulting product was a clear, green or brown solution having a pH of about 7.5. This micronutrient solution in 5 liters of water contained the following elements,

| | |
|---|---|
| N: | 140 grams |
| P: | 100 grams |
| K: | 280 grams |
| S: | 42 grams |
| Ca: | 20 grams |
| Mg: | 5 grams |
| Fe: | 100 milligrams |
| Mn: | 80 milligrams |
| Zn: | 33 milligrams |
| Cu: | 5 milligrams |
| Mo: | 50 milligrams |
| B: | 300 milligrams |

Compatibility between the micronutrient solution and the liquid fertilizer to be mixed with micronutrient is important. Generally, the metal cations are sufficiently chelated with strong chelating agents like aminophosphonic acids. If the metal cations are not sufficiently chelated then insoluble salts will form.

The foregoing description of the invention has been directed in primary part to particular preferred embodiments in accordance with the requirements of the Patent Statutes and for purposes of explanation and illustration. It will be apparent, however, to those skilled in the art that many modifications and changes in the specifically described methods may be made without departing from the true scope and spirit of the invention. For example, while ethylenediaminetetramethylene phosphonic acid is preferred, other aminophosphonic acids may be used. In fact, soluble salts of the organic acids may be used in place of the acids. Also, while it is preferred to dissolve the metal salt in an aqueous solution of the organic acid to which the base is then added, the order of additive does not appear to be critical. Therefore, the invention is not restricted to the preferred embodiments described and illustrated but covers all modifications which may fall within the scope of the following claims.

What is claimed is:

1. A micronutrient composition comprising:
an aminophosphonic acid, or a mixture of several aminophosphonic acids;
at least one metal oxide or metal salt wherein said metal is selected from the group consisting of calcium, magnesium, manganese, iron, cobalt, copper, zinc, molybdenum and mixtures thereof; and
basic chemicals selected from the group consisting of potassium hydroxide, sodium hydroxide, calcium oxide, calcium hydroxide, potassium carbonate, and sodium carbonate; and
inorganic chemicals including at least one nutrient selected from the group consisting of sulfur, potassium, nitrogen, phosphorus, and boron.

2. A micronutrient composition of claim 1 wherein all said chemical components are mixed and dissolved in water to form an aqueous solution before use.

3. A micronutrient composition of claim 1 wherein said aminophosphonic acid is selected from the group consisting of organic tri-phosphonic acids, tetra-phosphonic acids, penta-phosphonic acids and mixtures thereof.

4. A micronutrient composition in accordance with claim 3, wherein said triphosphonic acids are selected from the group consisting of nitrilotrimethylenephosphonic acid (NTMP), hydroxy-ethylenediaminetrimethylenephosphonic acid (HEDTMP), and mixtures thereof.

5. A micronutrient composition in accordance with claim 3, wherein said tetra-phosphonic acids are selected from the group consisting of bis-(aminomethyl)-norbornyltetramethylene-phosphonic acid (NBTP), ethylenediaminetetramethylenephosphonic acid (EDTMP), tetraazacyclododecanetetramethylene phosphonic acid (DOTMP), and mixtures thereof.

6. A micronutrient composition in accordance with claim 3, wherein said penta-phosphonic acid is diethylenetriaminepetnamethylene phosphonic acid (DTPMP).

7. The micronutrient composition of claim 1 wherein said metal is complexed by said aminophosphonic acid in aqueous solution.

8. The micronutrient composition of claim 2 wherein said complex was formed in aqueous solution by said aminophosphonic acid when water is introduced and the final pH of said solution is about 6.5-9.

9. The micronutrient composition of claim 2 wherein said composition contains about 0.000001 to about 5.0 percent-by-weight of said metal.

10. A liquid micronutrient composition or fertilizer additive composition, comprising: water and the micronutrient of claim 1;

11. The micronutrient composition or fertilizer additive composition of claim 10 wherein said metal—aminophosphonic acid complexes were formed in an aqueous solution and the pH of said solution is maintained at about 6.5-9, and aid composition contains about 0.000001 to about 5.0 percent-by-weight of said metal.

12. A method for providing metal ions and other nutrients to plants by administering to the soil in which the plants grow or to the foliage of the plant a liquid fertilizer composition comprising a fertilizer composition defined in claim 1, 2, 3, 4, 5, 6, 7, 8, or 9.

13. A method for preparing a liquid micronutrient composition or fertilizer additive, comprising:
adding an aminophosphonic acid to water to form an acidic solution or suspension;
dissolving a metal salt in said acidic solution wherein said metal is selected from the group consisting of the alkaline earth and transition metals and mixtures thereof;
adding to the above metal complex solution a sufficient quantity of basic chemicals selected from the group consisting of potassium hydroxide, sodium hydroxide, potassium carbonate, and sodium carbonate to maintain the pH of solution about 6.5-9,
adding to the resulting solution a sufficient quantity of inorganic chemicals including at least one nutrient selected from the group consisting of sulfur, potassium, nitrogen, phosphorus, and boron,
adding the resulting solution to certain quantity of water to prepare a diluted liquid fertilizer, or
adding the resulting solution to a liquid fertilizer solution including at least one nutrient selected from the group consisting of nitrogen, phosphorous and potassium to produce said liquid fertilizer composition.

14. A method of claim 13 wherein said aminophosphonic acid is selected from the group consisting of organic tri-phosphonic acids, tetra-phosphonic acids, penta-phosphonic acids and mixtures thereof.

15. A method of claim 13, wherein said triphosphonic acids are selected from the group consisting of nitrilotrimethylenephosphonic acid (NTMP) hydroxyethylenediaminetrimethylenephosphonic acid (HEDTMP), and mixtures thereof.

16. A method of claim 13, wherein said tetra-phosphonic acids are selected from the group consisting of bis-(aminomethyl)-norbornyltetramethylene-phosphonic acid (NBTP), ethylenediaminetetramethylenephosphonic acid (EDTMP), tetraazacyclododecanetetramethylene phosphonic acid (DOTMP), and mixtures thereof.

17. A method of claim 13, wherein said penta-phosphonic acid is diethylenetriaminepenta-methylene phosphonic acid (DTPMP).

18. A method of claim 13 wherein said metal is selected from the group consisting of calcium, magnesium, manganese, iron, cobalt, copper, zinc, molybdenum and mixtures thereof.

19. A method of claim 18 wherein said metal salt may be metal oxide or any biologically acceptable metal salt, such as chloride, sulfate nitrate, hydroxide and carbonate and other biologically compatible salts of the metal cation.

20. A method of claim 19 wherein said metal salt is added in a quantity sufficient so that the concentration of said metal in said liquid fertilizer composition is 0.00001 to about 5.0 percent-by-weight.

21. A method of claim 20 wherein the pH of said liquid micronutrient composition is maintained at 6.5-9.

22. A solid micronutrient composition or fertilizer additive composition, comprising:
a solid carrier and the micronutrient of claim 1;

23. A solid micronutrient composition or fertilizer additive composition of claim 22, wherein the said solid carrier is selected from a group of organic or inorganic polymer.

24. A solid micronutrient composition or fertilizer additive composition of claim 23, wherein the said organic or inorganic polymers comprising humic acid, fulvic acid and/or pearlite.
